(19) United States
(12) Patent Application Publication
(10) Pub. No.: US 2026/0197066 A1
(43) Pub. Date: Jul. 9, 2026

(54) COEFFICIENT REDUCTION FOR CHANNEL EMULATION

(71) Applicant: Telefonaktiebolaget LM Ericsson (publ), Stockholm (SE)

(72) Inventors: Hao ZHANG, Guangzhou (CN); Huaisong ZHU, Beijing (CN); Ming LEI, Guangzhou (CN); Fredrik HUSS, SUNDBYBERG (SE); Guangyu YUAN, Guangzhou (CN); Chao LI, Guangzhou (CN)

(21) Appl. No.: 19/133,310

(22) PCT Filed: Nov. 28, 2022
(86) PCT No.: PCT/CN2022/134659

§ 371 Date: May 28, 2025

(51) Int. Cl. H04B 7/06; H04B 17/391; H04L 25/02

(52) U.S. Cl. CPC H04B 7/06952; H04B 17/3912; H04L 25/0212

(57) ABSTRACT

The present disclosure is related to an electronic device and method for reducing a number of coefficients for channel emulation. A method for reducing a number of coefficients for channel emulation comprises: determining multiple beams based on at least first set of channel coefficients for channel emulation; selecting at least one beam from the multiple beams; and determining second set of channel coefficients for channel emulation based on at least the selected at least one beam, the number of channel coefficients in the second set of channel coefficients being less than the number of channel coefficients in the first set of channel coefficients.

### TECHNICAL FIELD

The present disclosure is related to the field of wireless communication, and in particular, to an electronic device and a method for reducing a number of coefficients for channel emulation.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

Channel emulation is a basic tool for the design and evaluation of a RAN. In channel emulation, the Transmitter (TX) and Receiver (RX) devices under test (DUTs) are physically connected to a channel emulator which is a box that simulates a configurable wireless channel between the two devices in real-time. The wireless channel is generally described via a multipath fading profile which can be configured to reproduce measured traces or standard profiles such as in the 3^{rd} Generation Partnership Project (3GPP) models. In contrast to over-the-air (OTA) testing, channel emulation enables reproducible and highly configurable test cases that can be performed at much lower costs.

### SUMMARY

The challenge with traditional channel emulation for mmWave and massive Multi-Input-Multi-Output (MIMO) scenarios is the need to support high-dimensional phased arrays (often >=64 antenna elements). The traditional channel emulation paradigm, when applied to DUTs having a large number of antenna elements, often becomes prohibitively time and power consuming. For example, an enormous number of coefficients for the filters in a channel emulator will be required to support a high-dimensional phased antenna array, resulting in a high computation load and a high energy cost which are not practically acceptable.

Therefore, to address or at least alleviate the problem, an electronic device and a method for reducing a number of coefficients for channel emulation is provided.

According to a first aspect of the present disclosure, a method for reducing a number of coefficients for channel emulation is provided. The method comprises: determining multiple beams based on at least first set of channel coefficients for channel emulation; selecting at least one beam from the multiple beams; and determining second set of channel coefficients for channel emulation based on at least the selected at least one beam, the number of channel coefficients in the second set of channel coefficients being less than the number of channel coefficients in the first set of channel coefficients.

In some embodiments, the channel coefficients in the first set of channel coefficients are full dimension channel coefficients for channel emulation. In some embodiments, before the step of determining the multiple beams, the method further comprises: generating the first set of channel coefficients based on one or more user inputs and/or one or more configurations. In some embodiments, the one or more user inputs and/or the one or more configurations comprise at least one of: one or more positions of one or more User Equipments (UEs); one or more speeds of one or more UEs; and one or more channel model parameters.

In some embodiments, before the step of determining the multiple beams, the method further comprises: receiving the first set of channel coefficients via one or more user inputs. In some embodiments, the step of determining the multiple beams comprises: determining a Spatial Discrete Fourier Transform (SDFT) based on at least a configuration for an antenna array of a Radio Access Network (RAN) node; and determining the multiple beams based on at least the determined SDFT and the first set of channel coefficients. In some embodiments, the configuration for the antenna array of the RAN node comprises at least one of: the number of columns of the antenna array; and the number of rows of the antenna array. In some embodiments, a coefficient matrix for the SDFT is determined as a Kronecker product of a 2-by-2 identity matrix, a horizontal matrix, and a vertical matrix, where each element in the horizontal matrix indicates a phase shift in the horizontal plane, where each element in the vertical matrix indicates a phase shift in the vertical plane.

In some embodiments, a coefficient vector for the multiple beams is determined for the channel coefficients in the first set of channel coefficients at the tap^{th} tap of the i^{th} snapshot, as follows:

$${\hat{h}}_{i}^{tap , r} = {W}_{SDFT} * {h}_{i}^{tap , r}$$

where W_{SDFT} is a coefficient matrix for the SDFT,

$${h}_{i}^{tap , r} ∈ ℂ ( {N}_{t} , 1 )$$

is a coefficient vector comprising the channel coefficients in the first set of channel coefficients for the r^{th} receiving antenna of a UE at the tap^{th} tap of the i^{th} snapshot,

$${\hat{h}}_{i}^{tap , r} ∈ ℂ ( {N}_{t} , 1 )$$

is a corresponding coefficient vector comprising coefficients for the multiple beams for the r^{th} receiving antenna of the UE at the tap^{th} tap of the i^{th} snapshot, and Nₜ is a number of transmitting antennas of the RAN node.

In some embodiments, before the step of selecting at least one beam from the multiple beams, the method further comprises: determining a power for each beam. In some embodiments, a power for a beam for a receiving antenna of a UE is determined as a sum of elements, which correspond to the beam, in all coefficient vectors for the receiving antenna of the UE for all taps of all snapshots. In some embodiments, a power for a beam is determined as follows:

$${P}^{r} ( b ) = {\sum }_{i = 1}^{{N}_{snapshot}} {\sum }_{tap = 1}^{{N}_{tap}} {\vert {\hat{h}}_{i}^{tap , r} ( b ) \vert}^{2}$$

where P^{r}(b) is the power for the b^{th} beam for an r^{th} receiving antenna of a UE,

$${\hat{h}}_{i}^{tap , r} ( b )$$

is an element, which corresponds to the b^{th} beam, in a coefficient vector for the r^{th} receiving antenna of the UE at the tap^{th} tap of the i^{th} snapshot, Nₜₐₚ is a number of taps in a snapshot, Nₛₙₐₚₛₕₒₜ is a number of snapshots, and |⋅| is an operator to calculate a magnitude of a complex number in |⋅|.

In some embodiments, the step of selecting at least one beam from the multiple beams comprises: selecting the at least one beam from the multiple beams based on at least the powers of the multiple beams. In some embodiments, after the step of determining the power for each beam and before the step of selecting the at least one beam from the multiple beams based on at least the powers of the multiple beams, the method further comprises: sorting the multiple beams by their powers in a descending order. In some embodiments, the step of selecting the at least one beam from the multiple beams based on at least the powers of the multiple beams comprises: selecting a maximum number of beams, for each of which a corresponding beam power is greater than or equal to that of any unselected beam, such that a ratio of a sum of the powers of the selected beams to a sum of the powers of all beams is less than or equal to a threshold.

In some embodiments, a number of N_{b} beams with the greatest powers are selected, and N_{b} is determined as follows:

$${N}_{b} = {arg max}_{\hat{{N}_{b}}} ( \frac{{\sum }_{d = 1}^{\hat{{N}_{b}}} {P}^{r ( {\hat{b}}_{d} )}}{{\sum }_{d = 1}^{{N}_{t}} {P}^{r ( {\hat{b}}_{d} )}} )$$

$$subjecting to$$

$$\frac{{\sum }_{d = 1}^{\hat{{N}_{b}}} {P}^{r} ( {\hat{b}}_{d} )}{{\sum }_{d = 1}^{{N}_{t}} {P}^{r} ( {\hat{b}}_{d} )} \leq x$$

where Nₜ is a number of transmitting antennas of the RAN node, \hat{b}_{d} is an index of a beam with the d^{th} greatest power, P^{r}(\hat{b}_{d}) is a power of the beam \hat{b}_{d}, argmax(⋅) is an operator to determine an argument [symbol] with which a function in (⋅) is maximized, and x is a threshold.

In some embodiments, after the step of selecting the at least one beam and before the step of determining the second set of channel coefficients for channel emulation, the method further comprises: determining a beam selection matrix based on the selected at least one beam. In some embodiments, elements of the beam selection matrix are determined as follows:

$${F}_{r} ( i , j ) = \{ \begin{matrix}1 & when i = k and j = {\hat{b}}_{k} , for k = 1 , 2 , … , {N}_{b} \\ 0 & otherwise\end{matrix}$$

where Fᵣ∈ [symbol] (N_{b}, Nₜ) is the beam selection matrix for the r^{th} receiving antenna of a UE, \hat{b}ₖ is an index of a beam with the k^{th} greatest power, and N_{b} is the number of the selected beams.

In some embodiments, the method further comprises: determining a beamforming matrix for converting signals, which are transmitted between a RAN node and a UE, from an antenna domain to a beam domain and/or from a beam domain to an antenna domain. In some embodiments, the beamforming matrix is determined as follows:

$${W}_{r} = {( {F}_{r} {W}_{SDFT} )}^{H}$$

where Wᵣ∈ [symbol] (Nₜ, N_{b}) is the beamforming matrix for the r^{th} antenna, Fᵣ is a beam selection matrix indicating the selected at least one beam for the r^{th} receiving antenna of the UE, W_{SDFT} is a coefficient matrix for an SDFT, Nₜ is a number of transmitting antennas of a RAN node, N_{b} is a number of beams that are selected, and (⋅)^{H} is an operator to determine an Hermitian transpose of a matrix in (⋅).

In some embodiments, the step of determining the second set of channel coefficients for channel emulation comprises: determining a coefficient vector comprising the channel coefficients in the second set of channel coefficients for a receiving antenna of a UE at a tap of a snapshot. In some embodiments, the coefficient vector comprising the channel coefficients in the second set of channel coefficients for the r^{th} receiving antenna of the UE at the tap^{th} tap of the i^{th} snapshot is determined as follows:

$${\tilde{h}}_{i}^{tap , r} = {F}_{r} * {\tilde{h}}_{i}^{tap , r} * α$$

where

$${\tilde{h}}_{i}^{tap , r}$$

is the coefficient vector comprising the channel coefficients in the second set of channel coefficients for the r^{th} receiving antenna of the UE at the tap^{th} tap of the i^{th} snapshot, Fᵣ is the beam selection matrix for the r^{th} receiving antenna of the UE,

$${\tilde{h}}_{i}^{tap , r}$$

is a corresponding coefficient vector comprising coefficients for the multiple beams for the r^{th} receiving antenna of the UE at the tap^{th} tap of the i^{th} snapshot, and a is a power scaling factor.

In some embodiments, the power scaling factor is determined as follows:

$$α = \sqrt{\frac{{\sum }_{d = 1}^{{N}_{t}} {P}^{r} ( {\hat{b}}_{d} )}{{\sum }_{d = 1}^{{N}_{b}} {P}^{r} ( {\hat{b}}_{d} )}}$$

where Nₜ is a number of transmitting antennas of a RAN node, N_{b} is a number of the selected at least one beam, \hat{b}_{d} is an index of a beam with the d^{th} greatest power, and P^{r}(\hat{b}_{d}) is a power of the beam \hat{b}_{d}.

In some embodiments, the method further comprises: receiving, from one of a RAN node and a UE, one or more input signals; processing the one or more input signals based on at least the second set of channel coefficients to determine one or more output signals; and transmitting, to the other of the RAN node and the UE, the one or more output signals. In some embodiments, when the one or more input signals are received from the RAN node, the step of processing the one or more input signals comprises: applying a first beamforming matrix to the one or more input signals to determine one or more beams; and applying a first Channel Impulse Response (CIR) matrix composed of the second set of channel coefficients to the one or more beams to determine the one or more output signals. In some embodiments, when the one or more input signals are received from the UE, the step of processing the one or more input signals comprises: applying a second CIR matrix to the input signals to determine one or more beams, the second CIR matrix being a transpose of the first CIR matrix; and applying a second beamforming matrix to the one or more beams to determine the one or more output signals, the second beamforming matrix being an inverse of the first beamforming matrix.

In some embodiments, when the one or more input signals received are analog signals, the method further comprises: converting the one or more input signals from the analog domain to the digital domain before the step of processing the one or more input signals is performed. In some embodiments, when the one or more output signals determined are digital signals, and when analog signals are to be transmitted, the method further comprises: converting the one or more output signals from the digital domain to the analog domain before the step of transmitting the one or more output signals is performed. In some embodiments, the method further comprises: determining a first average Doppler spread for the first set of channel coefficients; determining a second average Doppler spread for the second set of channel coefficients; and determining a performance degradation based on at least the first average Doppler spread and the second average Doppler spread. In some embodiments, an average Doppler spread for one or more coefficients is determined as follows: performing a Fast Fourier Transform (FFT) on the one or more coefficients to determine a frequency response corresponding to the one or more coefficients; determining a Doppler spectrum based on at least the determined frequency response; determining a variance of Doppler frequency offset spectrum based on at least the determined Doppler spectrum; and determining the average Doppler spread based on at least the determined RMS. In some embodiments, the method is performed at a Digital Channel Emulator (DiCE).

According to a second aspect of the present disclosure, an electronic device is provided. The electronic device comprises: a processor; a memory storing instructions which, when executed by the processor, cause the processor to perform any of the methods of the first aspect.

According to a third aspect of the present disclosure, an electronic device for reducing a number of coefficients for channel emulation is provided. The electronic device comprises: a first determining module configured to determine multiple beams based on at least first set of channel coefficients for channel emulation; a selecting module configured to select at least one beam from the multiple beams; and a second determining module configured to determine second set of channel coefficients for channel emulation based on at least the selected at least one beam, the number of channel coefficients in the second set of channel coefficients being less than the number of channel coefficients in the first set of channel coefficients. In some embodiments, the electronic device comprises one or more further modules, each of which may perform any of the steps of any of the methods of the first aspect.

According to a fourth aspect of the present disclosure, a computer program comprising instructions is provided. The instruction, when executed by at least one processor, cause the at least one processor to carry out any of the methods of the first aspect.

According to a fifth aspect of the present disclosure, a carrier containing the computer program of the fourth aspect. In some embodiments, the carrier is one of an electronic signal, optical signal, radio signal, or computer readable storage medium.

With some embodiments of the present disclosure, the computation load can be reduced (e.g., maybe up to 40%) to allow the energy saving in a channel emulator while supporting a good performance of propagation channel for a massive MIMO system. Further, the power consumption can be less (e.g., 40%) because some computation modules can be powered off, when compared with existing solutions. On the other hand, the memory for storing the channel coefficients can be reduced (e.g., by 40%).

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and therefore are not to be considered limiting of its scope, the disclosure will be described with additional specificity and detail through use of the accompanying drawings.

FIG. 1 is a diagram illustrating an exemplary environment for multipath propagation which can be emulated by a DiCE according to an embodiment of the present disclosure.

FIG. 2A and FIG. 2B are diagrams illustrating exemplary systems for reducing coefficients for channel emulation according to some embodiments of the present disclosure.

FIG. 3 is a diagram illustrating an exemplary procedure for channel dimension reduction according to an embodiment of the present disclosure.

FIG. 4 is a diagram illustrating performances in term of throughput when using coefficient reduction with different reduction levels according to an embodiment of the present disclosure.

FIG. 5 is a diagram illustrating performances in term of channel frequency offset Cumulative Distribution Function (CDF) when using coefficient reduction at different levels according to an embodiment of the present disclosure.

FIG. 6 is a flow chart illustrating an exemplary method for reducing a number of coefficients for channel emulation according to an embodiment of the present disclosure.

FIG. 7 schematically shows an embodiment of an arrangement which may be used in an electronic device according to an embodiment of the present disclosure.

FIG. 8 is a block diagram of an exemplary electronic device according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G New Radio (NR), the present disclosure is not limited thereto. In fact, as long as coefficient reduction for channel emulation is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division—Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5th Generation New Radio (5G NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, a RAN node, or any other equivalents.

Further, the following 3GPP document is incorporated herein by reference in their entireties:
3GPP TR 38.901 V17.0.0 (2022-03), Technical Report (TR), 3rd Generation Partnership Project; Technical Specification Group Radio Access Network; Study on channel model for frequencies from 0.5 to 100 GHz (Release 17).

In a wireless communication, there is a propagation channel between transmitters (TX) and the receivers (RX). In the channel, the electromagnetic wave may encounter reflection, diffraction, or scattering due to ambient obstacles such as buildings and trees, which results in many signal paths. For millimetre and terahertz bands, even small particles such as rains can block the direct link between two sides. In such circumstance, the network performance (e.g., throughput, Signal-to-Interference and Noise Ratio (SINR), coverage etc.) might be impacted significantly.

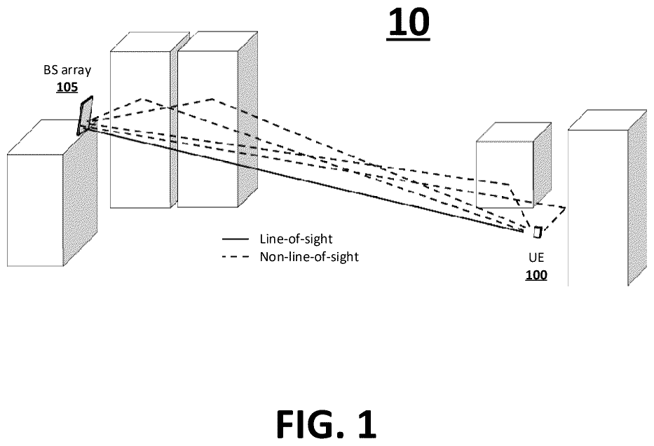

FIG. 1 illustrates a typical environment 10 for wireless communication with many signal paths (e.g., line-of-sight (LOS) and non-line-of-sight (NLOS)) between a base-station (BS) 105 and a user equipment (UE) 100. The resulting effect is referred to as multipath propagation, which is the main topic of wireless communication research.

It is worth noting that there are many channel environments in a wireless network, e.g., indoor, outdoor, rural, urban, etc. These channel environments are called channel models. The network products, like gNB and UE, must be tested and verified in as many as channel models because they might be deployed in multiple environments. Otherwise, the network performance might be good in some of the channel models but poor in the others.

There are many properties in a channel model, for example, angular spread due to scattering, delay spread due to multiple paths, Doppler shifts due to UE mobility. The cost for verifying the RAN performance in all the channel models in a wireless environment is high. Hence it would have great benefit if some methods can be provided to digitally test the network, instead of using real RF environment.

A Digital Channel Emulator (DiCE) is a device for supporting the digital test of a wireless communication system in a cable environment. It provides the environment to test the RAN performance with digital signals only, i.e., no RF or wireless environment is needed. Hence it can reduce the cost of verification for a RAN system significantly. This is a large advantage for a massive MIMO system which might have antenna elements up to hundred.

Meanwhile, a DiCE can simulate multiple channel models with different properties. This is needed in current multi-antenna RAN system which performs the massive MIMO transmission to achieve a high throughput and a large number of users. Hence many features like Multi-User MIMO (MU-MIMO), Reciprocity Assistant Transmission could be verified sufficiently in a digital environment. Therefore, the test efficiency would be improved tremendously.

However, two significant problems on current digital channel emulators are the high computation load and energy cost.

U.S. Pat. No. 7,890,821 depicts a system to emulate a 4×4 MIMO with the complex N-tap Finite Impulse Response (FIR) filter for each propagation path. As a result, 16 FIR filters are needed in this solution. The number of paths would increase dramatically when the number of TX or RX ports increases. For example, there would be 32*4=128 paths in a BS with 32 TX ports and UE with 4 RX ports. The computing cost is very high in such a solution.

U.S. Pat. No. 8,682,638 depicts a system to use Graphic Processing Unit (GPU)/Central Processing Unit (CPU) to do such computing, which has an advantage versus traditional hardware platform, e.g., Field Programmable Gate Array (FPGA). However, it does not have a solution to reduce the computation load, which is a concern when the number of TX/RX ports is increasing. For example, the number of TX ports might become one hundred in a high-band/mmWave system.

3GPP TR 38.901 and “Asplund, H., Medbo, J., Göransson, B., Karisson, J., Sköld, J.: “A simplified approach to applying the 3GPP spatial channel model”, in Proc. of PIMRC 2006” mentioned the channel coefficients processing in spatial domain. However no further method to reduce the complexity and computation load is provided.

Generally, the energy cost for supporting a high computation load in existing solutions is high. On the other hand, it is still a critical requirement to avoid a significant performance degradation on a channel model when trying to reduce the complexity or computation load of the channel model.

Therefore, some embodiments of the present disclosure provide a method to use Spatial Discrete Fourier Transform (SDFT) to do dimension reduction on channel coefficients. Here, the dimension reduction may be done in beam domain. In some embodiments, a key procedure to select and reduce the number of beams is disclosed. Further, in some embodiments, how to generate the channel coefficients to be applied to the FIR filters is described. The number of FIR filters is reduced significantly with this dimension reduction solution while the channel performance can be maintained.

In some embodiments, a beamforming matrix for traffic is also generated according to the dimension reduction algorithm. Then the traffic may be transmitted through a DiCE with alignment with the reduced dimension of channel.

In some embodiments, a method for Doppler spread analysis is also provided to verify the channel model performance after dimension reduction.

In some embodiments, following aspects are provided:
A method to do channel path (or channel beam) selection based on the spatial property of the channel model.
A solution to reduce the channel path and generate the channel coefficients.
Spatial property estimation on channel coefficients.
A solution to do the dimension reduction according to energy saving target.
A solution to support channel dimension reduction for both baseband and radio signals.
Alignment of channel dimension reduction and traffic in beam domain.
A Doppler analysis method to verify the performance of channel model after beam reductions.

With some embodiments of the present disclosure, the computation load can be reduced by up to 40% to allow the energy saving in a channel emulator while supporting a good performance of propagation channel for a massive MIMO system. Further, the power consumption is 40% less because some computation modules can be powered off, when compared with existing solutions. Currently it is verified on a 32×4 MIMO system that channel performance degradation is less than 2% after beam reduction to 8 beams. On the other hand, the memory to save the channel coefficients can be reduced by 40%. Further, the solution may support any interfaces for commercial or pre-commercial RAN equipment, e.g., digital, RF, Open-RAN.

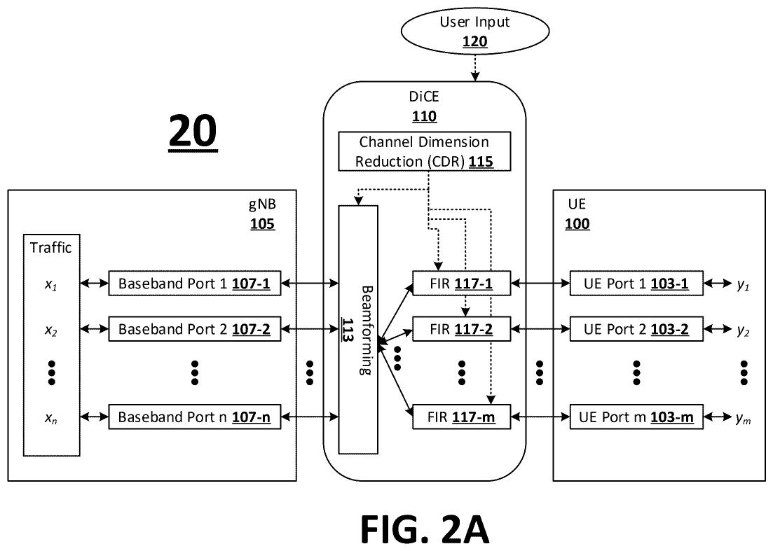

FIG. 2A and FIG. 2B are diagrams illustrating exemplary systems 20 and 20′ for reducing coefficients for channel emulation according to some embodiments of the present disclosure. As shown in FIG. 2A, an exemplary overall architecture 20 for channel emulation for digital interface is provided. The architecture 20 may comprise a gNB 105, one or more UEs 100, and a DiCE 110. In some embodiments, at least one of the gNB 105 and the one or more UEs 100 is under test.

As shown in FIG. 2A, there are n gNB baseband ports 107-1, 107-2, . . . , 107-n (collectively gNB baseband ports 107) and m UE ports 103-1, 103-2, . . . , 103-m (collectively UE ports 103). Therefore, it is a n*m MIMO system.

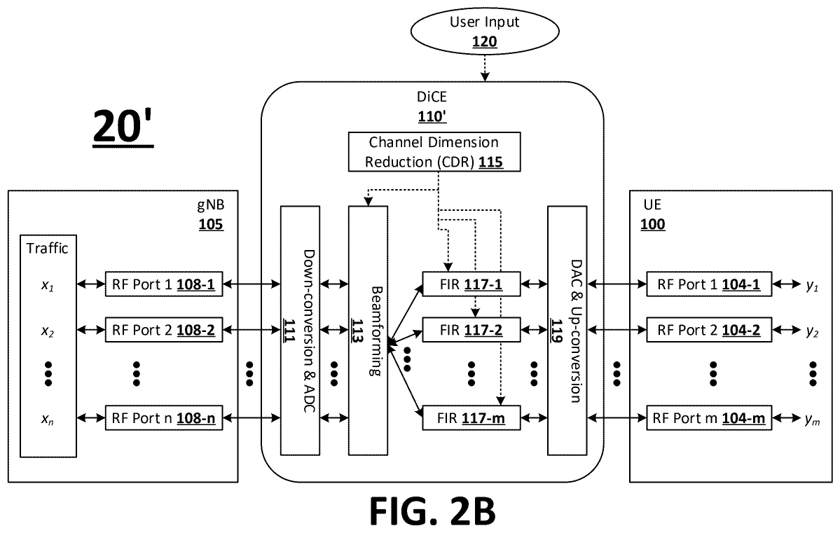

In some embodiments, a key module in the DiCE 110 is a channel dimension reduction (CDR) module 115. It may receive the user input or configurations 120, e.g., the channel model, energy saving target, etc. Then it may decide the number of channel paths to be reduced in beam domain. In this module 115, there are multiple signal processing steps, e.g., SDFT, beam power estimation, beam selection, reduction, etc., which will be described with reference to FIG. 3 below. The CDR module 115 may also output a beamforming matrix to a beamforming module 113 and output coefficients to one or more FIR filters 117-1, 117-2, . . . , 117-m (collectively, FIR filters 117). Then the traffic between the gNB 105 and the UE 100 may go through the beamforming module 113 and the FIR filters 117, its dimension may be reduced. For example, the traffic from the gNB 105 may go through the beamforming module 113 first, then through the FIR filters 117, and finally to the UE 100. For another example, the traffic from the UE 100 may go through the FIR filters 117 first, then the beamforming module 113 first, and finally to the gNB 105.

As shown in FIG. 2B, an exemplary overall system architecture 20′ for channel emulation for RF interface is provided. When compared with the architecture 20 shown in FIG. 2A, it is clear that the architecture 20′ may further comprise a down-conversion & Analog-to-Digital Conversion (ADC) module 111 and a Digital-to-Analog Conversion (DAC) & up-conversion module 119 to support the conversion between RF and digital signals. In some embodiments, other modules than the modules 111 and 119 are same as those shown in FIG. 2A, and the detail descriptions thereof are omitted for simplicity.

FIG. 3 is a diagram illustrating an exemplary procedure for channel dimension reduction according to an embodiment of the present disclosure. As shown in FIG. 3, at a block 310, full dimension channel coefficients may be generated. Firstly, the full dimension channel coefficients may be generated according to the user input and configurations 120, e.g., UE positions, speeds, channel model parameters, e.g., angular spread etc. In some embodiments, a user may input a part or all of the full dimension channel coefficients directly to the DiCE 110.

For each receiving antenna r at UE side, the following procedure may be performed for SDFT based beam reduction.

In some embodiments, denote Hᵢ∈ [symbol] (Nₜ, Nᵣ, Nₜₐₚ) as the channel impulse response (CIR) matrix of the i^{th} snapshot, where [symbol] (Nₜ, Nᵣ, Nₜₐₚ) refers to a complex matrix space, and each element or matrix in the space has dimensions of Nₜ×Nᵣ×Nₜₐₚ. Nₜ and Nᵣ are the number of transmitting and receiving antennas at gNB and UE side, respectively. Nₜₐₚ is the number of taps in one snapshot. Nₛₙₐₚₛₕₒₜ is the number of snapshots. In some embodiments, the term “snapshot” may refer to instantaneous channel impulse response. In some embodiments, a snapshot may be an instantaneous channel impulse response related to one or more transmitting antennas of a RAN node (e.g., the gNB 105), one or more receiving antennas of a UE (e.g., the UE 100), and one or more taps. In some embodiments, a snapshot may be an instantaneous channel impulse response related to all transmitting antennas of a RAN node (e.g., the gNB 105), all receiving antennas of a UE (e.g., the UE 100), and all taps.

In some embodiments, denote

$${h}_{i}^{tap , r} ∈ ℂ ( {N}_{t} , 1 )$$

as the CIR of the r^{th} receiving antenna on the tap^{th} tap of the i^{th} snapshot from Hᵢ∈ [symbol] (Nₜ, Nᵣ, Nₜₐₚ):

$${h}_{i}^{tap , r} = {H}_{i} ( : , r , tap )$$

In some embodiments, denote \tilde{H}ᵢ∈ [symbol] (N_{b}, Nᵣ, Nₜₐₚ) as the CIR after beam reduction, where N_{b} is the number of beams to be selected. In some embodiments, denote

$${\tilde{h}}_{i}^{tap , r} ∈ ℂ ( {N}_{b} , 1 )$$

as the CIR after beam reduction of the r^{th} receiving antenna on the tap^{th} tap of the i^{th} snapshot from \tilde{H}ᵢ:

$${\tilde{h}}_{i}^{tap , r} = {\tilde{H}}_{i} ( : , r , tap )$$

At block 320, CIR may be calculated in beam space with SDFT.

This block 320 aims to calculate the CIR in beam space with an SDFT matrix. In some embodiments, denote

$${\tilde{h}}_{i}^{tap , r} ∈ ℂ ( {N}_{t} , 1 )$$

as the CIR in beam space of the r^{th} receiving antenna on the tap^{th} tap of the i^{th} snapshot, and it is different from

$${\tilde{h}}_{i}^{tap , r}$$

defined above, which is an element of [symbol] (N_{b}, 1). In some embodiments,

$${\hat{h}}_{i}^{tap , r}$$

can be obtained as:

$${\hat{h}}_{i}^{tap , r} = {W}_{SDFT} + {h}_{i}^{tap , r}$$

where W_{SDFT}∈ [symbol] (Nₜ, Nₜ) is the SDFT matrix defined as follows.

R_{U} is the horizontal matrix and related to columns for the antenna array. U is the number of columns for the antenna array. R_{V} is the vertical matrix and related to rows of the antenna array. V is the number of rows for the antenna array. R_{P} is the matrix for polarization.

The conversion matrix W_{SDFT} is the Kronecker product of R_{P}, R_{U} and R_{V}.

$${R}_{U} = 1 / \sqrt{U} [ \begin{matrix}1 & 1 & ⋯ & 1 \\ {e}^{- {m}_{0}} & {e}^{- {m}_{1}} & ⋯ & {e}^{- {m}_{U - 1}} \\ ⋮ & ⋮ & ⋱ & ⋮ \\ {e}^{- ( U - 1 ) {m}_{0}} & {e}^{- ( U - 1 ) {m}_{1}} & ⋯ & {e}^{- ( U - 1 ) {m}_{U - 1}}\end{matrix} ] , {m}_{k} = \frac{j 2 π k}{U}$$

$${R}_{V} = 1 / \sqrt{V} [ \begin{matrix}1 & 1 & ⋯ & 1 \\ {e}^{- {n}_{0}} & {e}^{- {n}_{1}} & ⋯ & {e}^{- {n}_{V - 1}} \\ ⋮ & ⋮ & ⋱ & ⋮ \\ {e}^{- ( V - 1 ) {n}_{0}} & {e}^{- ( V - 1 ) {n}_{1}} & ⋯ & {e}^{- ( V - 1 ) {n}_{V - 1}}\end{matrix} ] , {m}_{k} = \frac{j 2 π k}{U}$$

$${R}_{P} = [ \begin{matrix}1 & 0 \\ 0 & 1\end{matrix} ]$$

$${W}_{SDFT} = {R}_{P} ⊗ {R}_{U} ⊗ {R}_{V}$$

At block 330, power for each beam may be estimated.

In some embodiments, the power of each beam may be calculated as:

$${P}^{r} ( b ) = {\sum }_{i = 1}^{{N}_{snapshot}} {\sum }_{tap = 1}^{{N}_{tap}} {\vert {\hat{h}}_{i}^{tap , r} ( b ) \vert}^{2} , b = 1 , 2 , … , {N}_{t}$$

where b is the beam index.

At block 340, beam selection, reduction, and beamforming matrix construction may be performed.

In some embodiments, P^{r} may be sorted in a descending order and the sorted beam index may be determined as [\hat{b}₁, \hat{b}₂, . . . , \hat{b}_{N}_{ₜ}].

The number of beams N_{b} can be determined by the threshold x∈(0,1] and the proportion of the selected beams as follows. In some embodiments, x may be determined according to the energy saving target from user input 120 and the channel performance requirement.

$${N}_{b} = {arg max}_{\text{?}} ( \frac{{\sum }_{d = 1}^{\text{?}} {P}^{r} ( {\hat{b}}_{d} )}{{\sum }_{d = 1}^{{N}_{t}} {P}^{r} ( {\hat{b}}_{d} )} )$$

$$subjecting to$$

$$( \frac{{\sum }_{d = 1}^{\text{?}} {P}^{r} ( {\hat{b}}_{d} )}{{\sum }_{d = 1}^{{N}_{t}} {P}^{r} ( {\hat{b}}_{d} )} ) \leq x$$

where \hat{b}_{d} is an index of a beam with the d^{th} greatest power and argmax(⋅) is an operator to determine an argument [symbol] with which a function in (⋅) is maximized.

The higher the threshold x is, the more beams are selected, and the more channel information is reserved, but the higher the computational load is.

Then the beam selection matrix Fᵣ∈ [symbol] (N_{b}, Nₜ) for antenna r can be constructed as

$${F}_{r} ( k , {\hat{b}}_{k} ) = 1 , k = 1 , 2 , … , {N}_{b}$$

In some embodiments, other elements in the beam selection matrix Fᵣ than those explicitly defined above can be 0.

The beamforming matrix Wᵣ∈ [symbol] (Nₜ, N_{b}) for antenna r can be obtained as

$${W}_{r} = {( {F}_{r} {W}_{SDFT} )}^{H}$$

At block 350, CIR Matrix may be generated.

In some embodiments, the CIR

$${\tilde{h}}_{i}^{tap , r} ∈ ℂ ( {N}_{b} , 1 )$$

after beam reduction with power scaling may be calculated as follows,

$${\tilde{h}}_{i}^{tap , r} = {F}_{r} * {\hat{h}}_{i}^{tap , r} * \sqrt{\frac{{\sum }_{d = 1}^{{N}_{t}} {P}^{r} ( {\hat{b}}_{d} )}{{\sum }_{d = 1}^{{N}_{b}} {P}^{r} ( {\hat{b}}_{d} )}}$$

where the term

$$\sqrt{\frac{{\sum }_{d = 1}^{{N}_{t}} {P}^{r} ( {\hat{b}}_{d} )}{{\sum }_{d = 1}^{{N}_{b}} {P}^{r} ( {\hat{b}}_{d} )}}$$

is used for power scaling to keep the power unchanged after beam reduction. In this way, the Ti for all receiving antennas and taps can be obtained.

Finally, the dimension of the CIR can be reduced from Nₜ to N_{b} and the computation load of convolution can be reduced. Further, with such SDFT based coefficient reduction, the channel performance can be maintained.

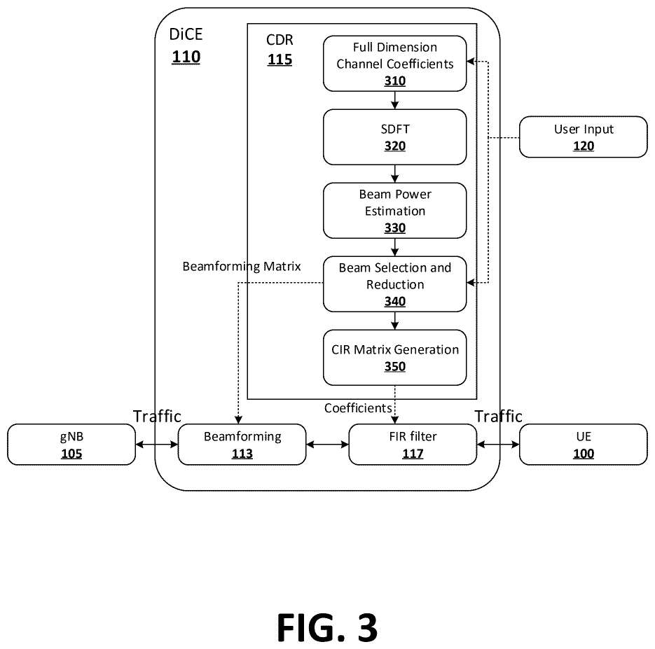

FIG. 4 is a diagram illustrating performances in term of throughput when using coefficient reduction with different reduction levels according to an embodiment of the present disclosure. To be specific, FIG. 4 provides performance results, and the baseline is the channel without beam reduction. With the proposed beam reduction algorithm described with reference to FIG. 2A, FIG. 2B, and FIG. 3, the performance degradation is less than 2% with reduction to 8 beams.

In some embodiments, a method to verify the channel emulator performance for different beam reduction levels is also provided. An exemplary algorithm and its steps are described in detail below.

Step 1. Fast Fourier Transform (FFT) may be done on the channel data of all slots, for one link, one subcarrier, one UE to get frequency response:

$$h = FFT ( H )$$

Step 2. The Doppler spectrum f_{d} can be obtained:

$${p}_{j} = \frac{{\vert {h}_{j} \vert}^{2}}{{\sum }_{j = 0}^{{N}_{FFT}} {\vert {h}_{j} \vert}^{2}} , {f}_{{d}_{j}} = \frac{j}{{T}_{s} \cdot {N}_{FFT}} , j = 0 , 1 , … , {N}_{FFT} - 1$$

where pⱼ is the normalized frequency power of sample j, N_{FFT} is the FFT size which is equal to the samples number in time domain, and TS is the sample interval in time domain.

Step 3. The variance of doppler frequency offset spectrum may be calculated:

$$E ( {f}_{d} ) = \frac{{\sum }_{j = 0}^{{N}_{FFT} - 1} {p}_{j} * {f}_{{d}_{j}}}{{\sum }_{j = 0}^{{N}_{FFT} - 1} {p}_{j}}$$

$$E ( {f}_{{d}^{2}} ) = \frac{{\sum }_{j = 0}^{{N}_{FFT} - 1} {p}_{j} * {( {f}_{{d}_{j}} )}^{2}}{{\sum }_{j = 0}^{{N}_{FFT} - 1} {p}_{j}}$$

$$variance ( {f}_{d} ) = \sqrt{E ( {f}_{d}^{2} ) - {( E ( {f}_{d} ) )}^{2}}$$

Step 4. The average Doppler spread for all links, all sub-carriers, and all UEs may be obtained.

Step 5. The average velocity may be obtained based on the Doppler frequency with peak power and UE angle of departure (AoD):

$$\overline{v} = \frac{\overline{{f}_{m}}}{{f}_{c}} c cos ( θ ) , {f}_{m} = {f}_{{d}_{i}} with max ( p )$$

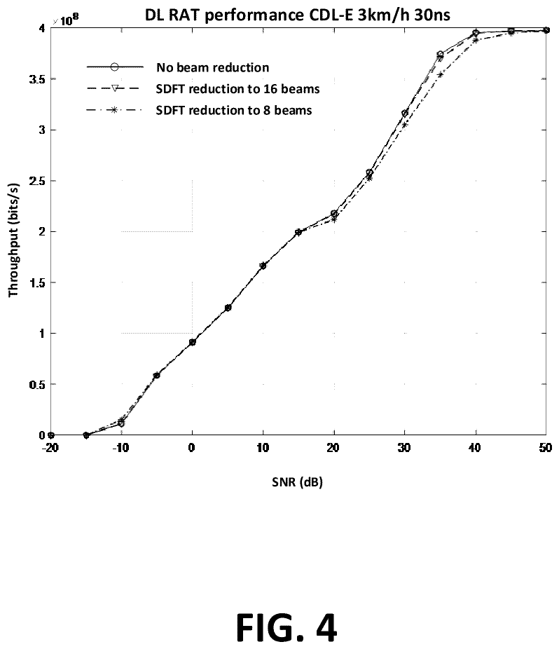

FIG. 5 is a diagram illustrating performances in term of channel frequency offset CDF when using coefficient reduction at different levels according to an embodiment of the present disclosure. To be specific, FIG. 5 provides Doppler spread CDF of different reduction levels. The baseline is the channel without beam reduction as shown by 510, 520, and 530 for different UE speeds. With the proposed beam reduction algorithm, the number of beams may be reduced from 32 to 16 (overlapped with 510, 520, 530, and cannot be distinguished therefrom), 8 (e.g., 521, 531), or even 4 (e.g., 511, 522, 532), without significant impact on Doppler spread.

Further, table 1 below indicates average Doppler spread and evaluated UE speed corresponding to those shown in FIG. 5.

TABLE 1

| UE Speed | | Number | Average Doppler | UE Speed |
|---|---|---|---|---|
| Setting | | of beams | Spread (Hz) | Evaluate (kmh) |
| 3 | kmh | No Reduction | 54.14 | 2.85 |
| | | 16 | 54.18 | 2.86 |
| | | 8 | 54.67 | 2.85 |
| | | 4 | 58.84 | 2.82 |
| 50 | kmh | No Reduction | 204.60 | 38.92 |
| | | 16 | 203.83 | 39.04 |
| | | 8 | 198.73 | 38.67 |
| | | 4 | 193.57 | 38.72 |
| 120 | kmh | No Reduction | 364.36 | 99.76 |

| | | |
|---|---|---|
| 16 | 364.32 | 99.74 |
| 8 | 361.91 | 99.87 |
| 4 | 358.49 | 100.97 |

Therefore, with some embodiments of the present disclosure, the computation load can be reduced by up to 40% to allow the energy saving in a channel emulator while supporting a good performance of propagation channel for a massive MIMO system. Further, the power consumption is 40% less because some computation modules can be powered off, when compared with existing solutions. Currently it is verified on a 32×4 MIMO system that channel performance degradation is less than 2% after beam reduction to 8 beams. On the other hand, the memory to save the channel coefficients can be reduced by 40%. Further, the solution may support any interfaces for commercial or pre-commercial RAN equipment, e.g. digital, RF, Open-RAN.

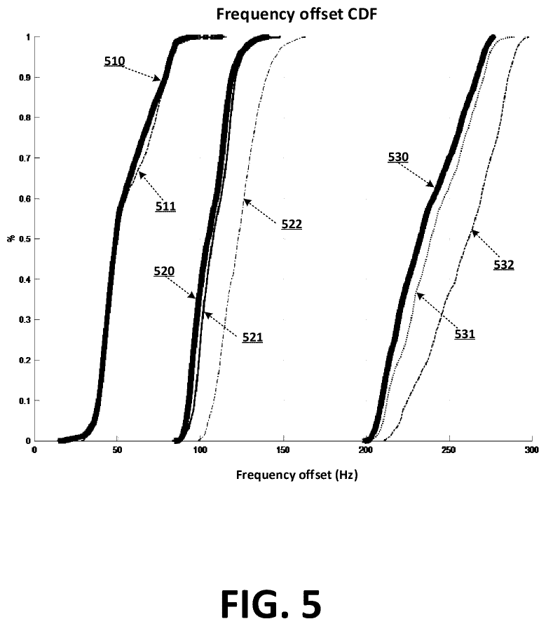

FIG. 6 is a flow chart of an exemplary method 600 for reducing a number of coefficients for channel emulation according to an embodiment of the present disclosure. The method 600 may be performed at an electronic device. The method 600 may comprise steps S610, S620, and step S630. However, the present disclosure is not limited thereto. In some other embodiments, the method 600 may comprise more steps, less steps, different steps or any combination thereof. Further the steps of the method 600 may be performed in a different order than that described herein. Further, in some embodiments, a step in the method 600 may be split into multiple sub-steps and performed by different entities, and/or multiple steps in the method 600 may be combined into a single step.

The method 600 may begin at step S610, where multiple beams may be determined based on at least first set of channel coefficients for channel emulation.

At step S620, at least one beam may be selected from the multiple beams.

At step S630, second set of channel coefficients for channel emulation may be determined based on at least the selected at least one beam, the number of channel coefficients in the second set of channel coefficients being less than the number of channel coefficients in the first set of channel coefficients.

In some embodiments, the channel coefficients in the first set of channel coefficients may be full dimension channel coefficients for channel emulation. In some embodiments, before the step of determining the multiple beams, the method 600 may further comprise: generating the first set of channel coefficients based on one or more user inputs and/or one or more configurations. In some embodiments, the one or more user inputs and/or the one or more configurations may comprise at least one of: one or more positions of one or more UEs; one or more speeds of one or more UEs; and one or more channel model parameters.

In some embodiments, before the step of determining the multiple beams, the method 600 may further comprise: receiving the first set of channel coefficients via one or more user inputs. In some embodiments, the step of determining the multiple beams may comprise: determining an SDFT based on at least a configuration for an antenna array of a RAN node; and determining the multiple beams based on at least the determined SDFT and the first set of channel coefficients. In some embodiments, the configuration for the antenna array of the RAN node may comprise at least one of: the number of columns of the antenna array; and the number of rows of the antenna array. In some embodiments, a coefficient matrix for the SDFT may be determined as a Kronecker product of a 2-by-2 identity matrix, a horizontal matrix, and a vertical matrix, where each element in the horizontal matrix indicates a phase shift in the horizontal plane, where each element in the vertical matrix indicates a phase shift in the vertical plane.

In some embodiments, a coefficient vector for the multiple beams may be determined for the channel coefficients in the first set of channel coefficients at the tap^{th} tap of the i^{th} snapshot, as follows:

$${\hat{h}}_{i}^{tap , r} = {W}_{SDFT} * {h}_{i}^{tap , r}$$

where W_{SDFT} is a coefficient matrix for the SDFT,

$${h}_{i}^{tap , r} ∈ ℂ ( {N}_{t} , 1 )$$

is a coefficient vector comprising the channel coefficients in the first set of channel coefficients for the r^{th} receiving antenna of a UE at the tap^{th} tap of the i^{th} snapshot,

$${\hat{h}}_{i}^{tap , r} ∈ ℂ ( {N}_{t} , 1 )$$

is a corresponding coefficient vector comprising coefficients for the multiple beams for the r^{th} receiving antenna of the UE at the tap^{th} tap of the i^{th} snapshot, and Nₜ is a number of transmitting antennas of the RAN node.

In some embodiments, before the step of selecting at least one beam from the multiple beams, the method 600 may further comprise: determining a power for each beam. In some embodiments, a power for a beam for a receiving antenna of a UE may be determined as a sum of elements, which correspond to the beam, in all coefficient vectors for the receiving antenna of the UE for all taps of all snapshots. In some embodiments, a power for a beam may be determined as follows:

$${P}^{r} ( b ) = {\sum }_{i = 1}^{{N}_{snapshot}} {\sum }_{tap = 1}^{{N}_{tap}} {\vert {\hat{h}}_{i}^{tap , r} ( b ) \vert}^{2}$$

where P^{r}(b) is the power for the b^{th} beam for an r^{th} receiving antenna of a UE,

$${\hat{h}}_{i}^{tap , r} ( b )$$

is an element, which corresponds to the b^{th} beam, in a coefficient vector for the r^{th} receiving antenna of the UE at the tap^{th} tap of the i^{th} snapshot, Nₜₐₚ is a number of taps in a snapshot, Nₛₙₐₚₛₕₒₜ is a number of snapshots, and |⋅| is an operator to calculate a magnitude of a complex number in |⋅|.

In some embodiments, the step of selecting at least one beam from the multiple beams may comprise: selecting the at least one beam from the multiple beams based on at least the powers of the multiple beams. In some embodiments, after the step of determining the power for each beam and before the step of selecting the at least one beam from the multiple beams based on at least the powers of the multiple beams, the method 600 may further comprise: sorting the multiple beams by their powers in a descending order. In some embodiments, the step of selecting the at least one beam from the multiple beams based on at least the powers of the multiple beams may comprise: selecting a maximum number of beams, for each of which a corresponding beam power is greater than or equal to that of any unselected beam, such that a ratio of a sum of the powers of the selected beams to a sum of the powers of all beams is less than or equal to a threshold.

In some embodiments, a number of N_{b} beams with the greatest powers may be selected, and N_{b} may be determined as follows:

$${N}_{b} = \text{?} ( \frac{\text{?} {P}^{r} ( {\hat{b}}_{d} )}{{\sum }_{d = 1}^{{N}_{t}} {P}^{r} ( {\hat{b}}_{d} )} )$$

$$subjecting to$$

$$\frac{\text{?} {P}^{r} ( {\hat{b}}_{d} )}{{\sum }_{d = 1}^{{N}_{t}} {P}^{r} ( {\hat{b}}_{d} )} \leq x$$

where Nₜ is a number of transmitting antennas of the RAN node, \hat{b}_{d} is an index of a beam with the d^{th} greatest power, P^{r}(\hat{b}_{d}) is a power of the beam \hat{b}_{d}, argmax(⋅) is an operator to determine an argument [symbol] with which a function in (⋅) is maximized, and x is a threshold.

In some embodiments, after the step of selecting the at least one beam and before the step of determining the second set of channel coefficients for channel emulation, the method 600 may further comprise: determining a beam selection matrix based on the selected at least one beam. In some embodiments, elements of the beam selection matrix may be determined as follows:

$${F}_{r} ( i , j ) = \{ \begin{matrix}1 & when i = k and j = {\hat{b}}_{k} , f or k = 1 , 2 , … , {N}_{b} \\ 0 & otherwise\end{matrix}$$

where Fᵣ∈ [symbol] (N_{b}, Nₜ) is the beam selection matrix for the r^{th} receiving antenna of a UE, \hat{b}ₖ is an index of a beam with the k^{th} greatest power, and N_{b} is the number of the selected beams.

In some embodiments, the method 600 may further comprise: determining a beamforming matrix for converting signals, which are transmitted between a RAN node and a UE, from an antenna domain to a beam domain and/or from a beam domain to an antenna domain. In some embodiments, the beamforming matrix may be determined as follows:

$${W}_{r} = {( {F}_{r} {W}_{SDFT} )}^{H}$$

where Wᵣ∈ [symbol] (Nₜ, N_{b}) is the beamforming matrix for the r^{th} antenna, Fᵣ is a beam selection matrix indicating the selected at least one beam for the r^{th} receiving antenna of the UE, W_{SDFT} is a coefficient matrix for an SDFT, Nₜ is a number of transmitting antennas of a RAN node, N_{b} is a number of beams that are selected, and (⋅)^{H} is an operator to determine an Hermitian transpose of a matrix in (⋅).

In some embodiments, the step of determining the second set of channel coefficients for channel emulation may comprise: determining a coefficient vector comprising the channel coefficients in the second set of channel coefficients for a receiving antenna of a UE at a tap of a snapshot. In some embodiments, the coefficient vector comprising the channel coefficients in the second set of channel coefficients for the r^{th} receiving antenna of the UE at the tap^{th} tap of the i^{th} snapshot may be determined as follows:

$${\tilde{h}}_{i}^{tap , r} = {F}_{r} * {\hat{h}}_{i}^{tap , r} * α$$

where

$${\tilde{h}}_{i}^{tap , r}$$

is the coefficient vector comprising the channel coefficients in the second set of channel coefficients for the r^{th} receiving antenna of the UE at the tap^{th} tap of the i^{th} snapshot, Fᵣ is the beam selection matrix for the r^{th} receiving antenna of the UE,

$${\hat{h}}_{i}^{tap , r}$$

is a corresponding coefficient vector comprising coefficients for the multiple beams for the r^{th} receiving antenna of the UE at the tap^{th} tap of the i^{th} snapshot, and a is a power scaling factor.

In some embodiments, the power scaling factor may be determined as follows:

$$α = \frac{{\sum }_{d = 1}^{{N}_{t}} {P}^{r} ( {\hat{b}}_{d} )}{{\sum }_{d = 1}^{{N}_{b}} {P}^{r} ( {\hat{b}}_{d} )}$$

where Nₜ is a number of transmitting antennas of a RAN node, N_{b} is a number of the selected at least one beam, \hat{b}_{d} is an index of a beam with the d^{th} greatest power, and P^{r}(\hat{b}_{d}) is a power of the beam \hat{b}_{d}.

In some embodiments, the method 600 may further comprise: receiving, from one of a RAN node and a UE, one or more input signals; processing the one or more input signals based on at least the second set of channel coefficients to determine one or more output signals; and transmitting, to the other of the RAN node and the UE, the one or more output signals. In some embodiments, when the one or more input signals are received from the RAN node, the step of processing the one or more input signals may comprise: applying a first beamforming matrix to the one or more input signals to determine one or more beams; and applying a first CIR matrix composed of the second set of channel coefficients to the one or more beams to determine the one or more output signals. In some embodiments, when the one or more input signals are received from the UE, the step of processing the one or more input signals may comprise: applying a second CIR matrix to the input signals to determine one or more beams, the second CIR matrix being a transpose of the first CIR matrix; and applying a second beamforming matrix to the one or more beams to determine the one or more output signals, the second beamforming matrix being an inverse of the first beamforming matrix.

In some embodiments, when the one or more input signals received are analog signals, the method 600 may further comprise: converting the one or more input signals from the analog domain to the digital domain before the step of processing the one or more input signals is performed. In some embodiments, when the one or more output signals determined are digital signals, and when analog signals are to be transmitted, the method 600 may further comprise: converting the one or more output signals from the digital domain to the analog domain before the step of transmitting the one or more output signals is performed. In some embodiments, the method 600 may further comprise: determining a first average Doppler spread for the first set of channel coefficients; determining a second average Doppler spread for the second set of channel coefficients; and determining a performance degradation based on at least the first average Doppler spread and the second average Doppler spread. In some embodiments, an average Doppler spread for one or more coefficients may be determined as follows: performing an FFT on the one or more coefficients to determine a frequency response corresponding to the one or more coefficients; determining a Doppler spectrum based on at least the determined frequency response; determining a variance of Doppler frequency offset spectrum based on at least the determined Doppler spectrum; and determining the average Doppler spread based on at least the determined RMS. In some embodiments, the method 600 may be performed at a DiCE.

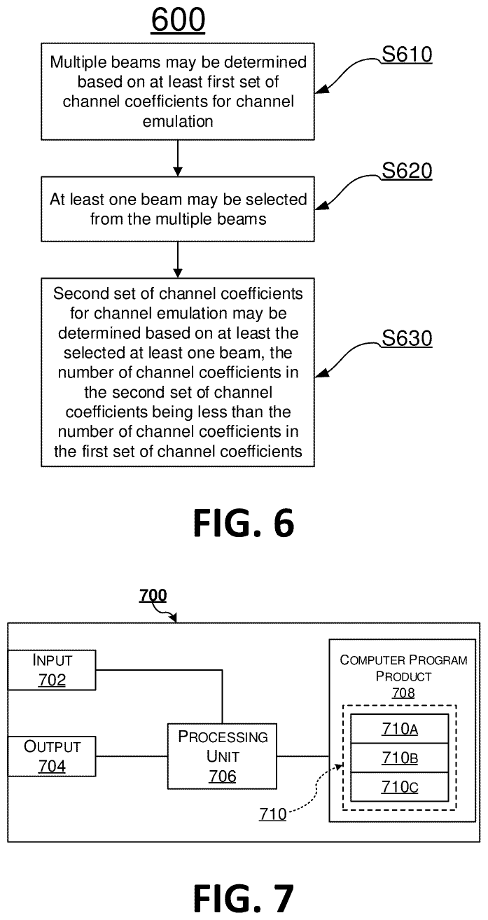

FIG. 7 schematically shows an embodiment of an arrangement 700 which may be used in an electronic device according to an embodiment of the present disclosure. Comprised in the arrangement 700 are a processing unit 706, e.g., with a Digital Signal Processor (DSP) or a Central Processing Unit (CPU). The processing unit 706 may be a single unit or a plurality of units to perform different actions of procedures described herein. The arrangement 700 may also comprise an input unit 702 for receiving signals from other entities, and an output unit 704 for providing signal(s) to other entities. The input unit 702 and the output unit 704 may be arranged as an integrated entity or as separate entities.

Furthermore, the arrangement 700 may comprise at least one computer program product 708 in the form of a non-volatile or volatile memory, e.g., an Electrically Erasable Programmable Read-Only Memory (EEPROM), a flash memory and/or a hard drive. The computer program product 708 comprises a computer program 710, which comprises code/computer readable instructions, which when executed by the processing unit 706 in the arrangement 700 causes the arrangement 700 and/or the electronic device in which it is comprised to perform the actions, e.g., of the procedure described earlier in conjunction with FIG. 2A through FIG. 3 and FIG. 6 or any other variant.

The computer program 710 may be configured as a computer program code structured in computer program modules 710A, 710B, and 710C. Hence, in an exemplifying embodiment when the arrangement 700 is used in an electronic device for reducing a number of coefficients for channel emulation, the code in the computer program of the arrangement 700 includes: a module 710A configured to determine multiple beams based on at least first set of channel coefficients for channel emulation; a module 710B configured to select at least one beam from the multiple beams; and a module 710C configured to determine second set of channel coefficients for channel emulation based on at least the selected at least one beam, the number of channel coefficients in the second set of channel coefficients being less than the number of channel coefficients in the first set of channel coefficients.

The computer program modules could essentially perform the actions of the flow illustrated in FIG. 2A through FIG. 3 and FIG. 6, to emulate the electronic device. In other words, when the different computer program modules are executed in the processing unit 706, they may correspond to different modules in the electronic device.

Although the code means in the embodiments disclosed above in conjunction with FIG. 7 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the electronic device.

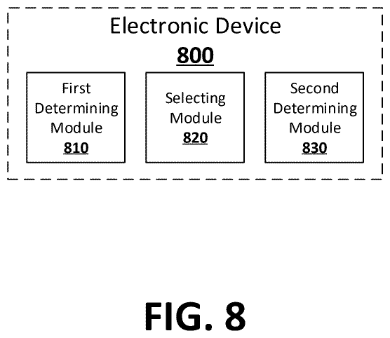

Correspondingly to the method 600 as described above, an electronic device 800 for reducing a number of coefficients for channel emulation is provided. FIG. 8 is a block diagram of an exemplary electronic device 800 according to an embodiment of the present disclosure. The electronic device 800 can be e.g., the DiCE 110.

The electronic device 800 can be configured to perform the method 600 as described above in connection with FIG. 6. As shown in FIG. 8, the electronic device 800 may comprise a first determining module 810 configured to determine multiple beams based on at least first set of channel coefficients for channel emulation; a selecting module 820 configured to select at least one beam from the multiple beams; and a second determining module 830 configured to determine second set of channel coefficients for channel emulation based on at least the selected at least one beam, the number of channel coefficients in the second set of channel coefficients being less than the number of channel coefficients in the first set of channel coefficients.

The above modules 810, 820, and/or 830 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 6. Further, the electronic device 800 may comprise one or more further modules, each of which may perform any of the steps of the method 600 described with reference to FIG. 6.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method for reducing a number of coefficients for channel emulation, the method comprising:
determining multiple beams based on at least first set of channel coefficients for channel emulation;
selecting at least one beam from the multiple beams; and
determining second set of channel coefficients for channel emulation based on at least the selected at least one beam, the number of channel coefficients in the second set of channel coefficients being less than the number of channel coefficients in the first set of channel coefficients.

2. The method of claim 1, wherein the channel coefficients in the first set of channel coefficients are full dimension channel coefficients for channel emulation.

3. The method of claim 1, wherein before the step of determining the multiple beams, the method further comprises:
generating the first set of channel coefficients based on one or more user inputs and/or one or more configurations.

4. The method of claim 3, wherein the one or more user inputs and/or the one or more configurations comprise at least one of:
one or more positions of one or more User Equipments (UEs);
one or more speeds of one or more UEs; and
one or more channel model parameters.

5. The method of claim 1, wherein before the step of determining the multiple beams, the method further comprises:
receiving the first set of channel coefficients via one or more user inputs.

6. The method of claim 1, wherein the step of determining the multiple beams comprises:
determining a Spatial Discrete Fourier Transform (SDFT) based on at least a configuration for an antenna array of a Radio Access Network (RAN) node; and
determining the multiple beams based on at least the determined SDFT and the first set of channel coefficients.

7. The method of claim 6, wherein the configuration for the antenna array of the RAN node comprises at least one of:
the number of columns of the antenna array; and
the number of rows of the antenna array.

8. The method of claim 6, wherein a coefficient matrix for the SDFT is determined as a Kronecker product of a 2-by-2 identity matrix, a horizontal matrix, and a vertical matrix,
where each element in the horizontal matrix indicates a phase shift in the horizontal plane,
where each element in the vertical matrix indicates a phase shift in the vertical plane.

9. The method of claim 6, wherein a coefficient vector for the multiple beams is determined for the channel coefficients in the first set of channel coefficients at the tap^{th} tap of the i^{th} snapshot, as follows:
$${\hat{h}}_{i}^{tap , r} = {W}_{SDFT} * {h}_{i}^{tap , r}$$
where W_{SDFT} is a coefficient matrix for the SDFT,
$${h}_{i}^{tap , r} ∈ ℂ ( {N}_{t} , 1 )$$
is a coefficient vector comprising the channel coefficients in the first set of channel coefficients for the r^{th} receiving antenna of a UE at the tap^{th} tap of the i^{th} snapshot,
$${\hat{h}}_{i}^{tap , r} ∈ ℂ ( {N}_{t} , 1 )$$
is a corresponding coefficient vector comprising coefficients for the multiple beams for the r^{th} receiving antenna of the UE at the tap^{th} tap of the i^{th} snapshot, and Nₜ is a number of transmitting antennas of the RAN node.

10. The method of claim 1, wherein before the step of selecting at least one beam from the multiple beams, the method further comprises:
determining a power for each beam.

11. The method of claim 10, wherein a power for a beam for a receiving antenna of a UE is determined as a sum of elements, which correspond to the beam, in all coefficient vectors for the receiving antenna of the UE for all taps of all snapshots.

12-23. (canceled)

24. The method of claim 1, further comprising:
receiving, from one of a RAN node and a UE, one or more input signals;
processing the one or more input signals based on at least the second set of channel coefficients to determine one or more output signals; and
transmitting, to the other of the RAN node and the UE, the one or more output signals.

25. The method of claim 24, wherein when the one or more input signals are received from the RAN node, the step of processing the one or more input signals comprises:
applying a first beamforming matrix to the one or more input signals to determine one or more beams; and
applying a first Channel Impulse Response (CIR) matrix composed of the second set of channel coefficients to the one or more beams to determine the one or more output signals.

26. The method of claim 24, wherein when the one or more input signals are received from the UE, the step of processing the one or more input signals comprises:
applying a second CIR matrix to the input signals to determine one or more beams, the second CIR matrix being a transpose of the first CIR matrix; and
applying a second beamforming matrix to the one or more beams to determine the one or more output signals, the second beamforming matrix being an inverse of the first beamforming matrix.

27. The method of claim 24, wherein when the one or more input signals received are analog signals, the method further comprises:
converting the one or more input signals from the analog domain to the digital domain before the step of processing the one or more input signals is performed.

28. The method of claim 24, wherein when the one or more output signals determined are digital signals, and when analog signals are to be transmitted, the method further comprises:
converting the one or more output signals from the digital domain to the analog domain before the step of transmitting the one or more output signals is performed.

29. The method of claim 24, further comprising:
determining a first average Doppler spread for the first set of channel coefficients;
determining a second average Doppler spread for the second set of channel coefficients; and
determining a performance degradation based on at least the first average Doppler spread and the second average Doppler spread.

30. The method of claim 29, wherein an average Doppler spread for one or more coefficients is determined as follows:
performing a Fast Fourier Transform (FFT) on the one or more coefficients to determine a frequency response corresponding to the one or more coefficients;
determining a Doppler spectrum based on at least the determined frequency response;
determining a variance of Doppler frequency offset spectrum based on at least the determined Doppler spectrum; and
determining the average Doppler spread based on at least the determined RMS.

31. The method of claim 1, wherein the method is performed at a Digital Channel Emulator (DiCE).

32. An electronic device, comprising:
a processor;
a memory storing instructions which, when executed by the processor, cause the processor to perform the method of claim 1.

33-34. (canceled)
